(19) United States
(12) Patent Application Publication
(10) Pub. No.: US 2023/0137018 A1
(43) Pub. Date: May 4, 2023

(54) COIL COMPONENT

(71) Applicant: SAMSUNG ELECTRO-MECHANICS CO., LTD., Suwon-si (KR)

(72) Inventors: Jae Wook LEE, Suwon-si (KR); In Young KANG, Suwon-si (KR); Sung Kwon OH, Suwon-si (KR)

(73) Assignee: SAMSUNG ELECTRO-MECHANICS CO., LTD., Suwon-si (KR)

(21) Appl. No.: 17/969,178

(22) Filed: Oct. 19, 2022

(30) Foreign Application Priority Data
Oct. 29, 2021 (KR) 10-2021-0146408

(51) Int. Cl. H01F 27/28; H01F 27/32; H01F 27/02; H01F 27/29; H01F 1/20

(52) U.S. Cl. CPC H01F 27/2852; H01F 27/327; H01F 27/022; H01F 27/29; H01F 1/20

(57) ABSTRACT

A coil component includes a body including magnetic powder particles and an insulating resin, a coil portion disposed in the body and including a lead-out portion exposed to one surface of the body, and an external electrode disposed on one surface of the body. The external electrode includes an intermetallic compound (IMC) disposed on the lead-out portion exposed to one surface of the body and having an average thickness of 1 μm or more, and a first electrode layer including a base resin, and a conductive connection portion disposed in the base resin and in contact with the intermetallic compound.

### CROSS-REFERENCE TO RELATED APPLICATION(S)

This application claims the benefit under 35 USC 119(a) of Korean Patent Application No. 10-2021-0146408 filed on Oct. 29, 2021 in the Korean Intellectual Property Office, the entire disclosure of which is incorporated herein by reference for all purposes.

### TECHNICAL FIELD

The present disclosure relates to a coil component.

### BACKGROUND

Inductors, coil components, are typical passive electronic components used in electronic devices along with resistors and capacitors.

In the case of a coil component, in general, a body having a coil portion disposed therein is formed, and an external electrode is formed on the surface of the body to complete the component. In this case, coupling force between the body and the external electrode may be problematic, and contact resistance between the external electrode and the coil portion may be problematic.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

An aspect of the present disclosure is to provide a coil component in which bonding force between a body and an external electrode may be increased.

An aspect of the present disclosure is to provide a coil component in which component characteristics may be improved by reducing resistance between a lead-out portion and an external electrode.

According to an aspect of the present disclosure, a coil component includes a body including magnetic powder particles and an insulating resin; a coil portion disposed in the body and including a lead-out portion exposed to one surface of the body; and an external electrode disposed on one surface of the body. The external electrode includes an intermetallic compound (IMC) disposed on the lead-out portion exposed to one surface of the body and having an average thickness of 1 μm or more, and a first electrode layer including a base resin, and a conductive connection portion disposed in the base resin and in contact with the intermetallic compound.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a view schematically illustrating a coil component according to an embodiment;

FIG. 2 is a view schematically illustrating a cross-section taken along line I-I′ of FIG. 1;

FIG. 3 is a diagram schematically illustrating enlarged area A of FIG. 2;

FIG. 4 is an enlarged view of a region corresponding to area A of FIG. 2 for a modified example of the coil component illustrated in FIG. 1;

FIG. 5 is an enlarged view of a region corresponding to area A of FIG. 2 for another modified example of the coil component illustrated in FIG. 1;

FIG. 6 is an enlarged view of an area corresponding to area A of FIG. 2 for another modified example of the coil component illustrated in FIG. 1;

FIG. 7 is a view schematically illustrating a modified example of an external electrode of the coil component illustrated in FIG. 1;

FIG. 8 is a view schematically illustrating a coil component according to another embodiment;

FIG. 9 is a view schematically illustrating a mold portion applied to the coil component illustrated in FIG. 8;

FIG. 10 is a view schematically illustrating a cross-section taken along line II-II′ of FIG. 8;

FIG. 11 is a diagram schematically illustrating enlarged area B of FIG. 10;

FIG. 12 is a view schematically illustrating a modified example of the external electrode of the coil component illustrated in FIG. 11;

FIG. 13 is a view schematically illustrating a cross-section taken along line III-III′ of FIG. 12;

FIG. 14 is a view schematically illustrating a coil component according to another embodiment;

FIG. 15 is a view schematically illustrating a cross-section taken along line IV-IV′ of FIG. 14; and

FIG. 16 is a diagram schematically illustrating enlarged area D of FIG. 15.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided and thus, this disclosure will be thorough and complete, and will fully convey the scope of the disclosure to one of ordinary skill in the art.

Herein, it is noted that use of the term “may” with respect to an embodiment or example, e.g., as to what an embodiment or example may include or implement, means that at least an embodiment or example exists in which such a feature is included or implemented while all examples and examples are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. Throughout the specification, “on” means to be located above or below the target part, and does not necessarily mean to be located above the direction of gravity. The device may also be oriented in other manners (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the detailed shapes illustrated in the drawings, but include changes in shape occurring during manufacturing.

The features of the examples described herein may be combined in various manners as will be apparent after gaining an understanding of the disclosure of this application. Further, although the examples described herein have a variety of configurations, other configurations are possible as will be apparent after gaining an understanding of the disclosure of this application.

The drawings may not be to scale, and the relative sizes, proportions, and depiction of elements in the drawings may be exaggerated for clarity, illustration, and convenience.

In the drawings, an L direction may be defined as a first direction or a length direction, a W direction may be defined as a second direction or a width direction, and a T direction may be defined as a third direction or a thickness direction.

Hereinafter, a coil component according to an embodiment will be described in detail with reference to the accompanying drawings, and in the description with reference to the accompanying drawings, the same or corresponding components are given the same reference numerals, and the overlapping description thereof will be omitted.

Various types of electronic components are used in electronic devices, and among these electronic components, various types of coil components may be appropriately used for removing noise and the like.

For example, in electronic devices, a coil component may be used as a power inductor, a high frequency inductor, a general bead, a high frequency bead (GHz Bead), a common mode filter, or the like.

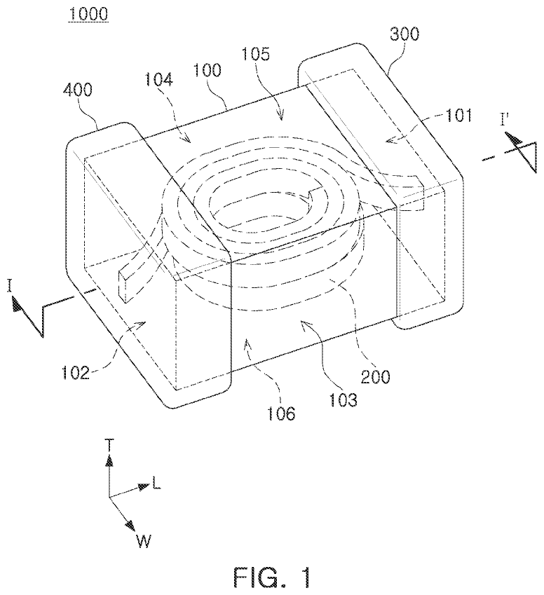

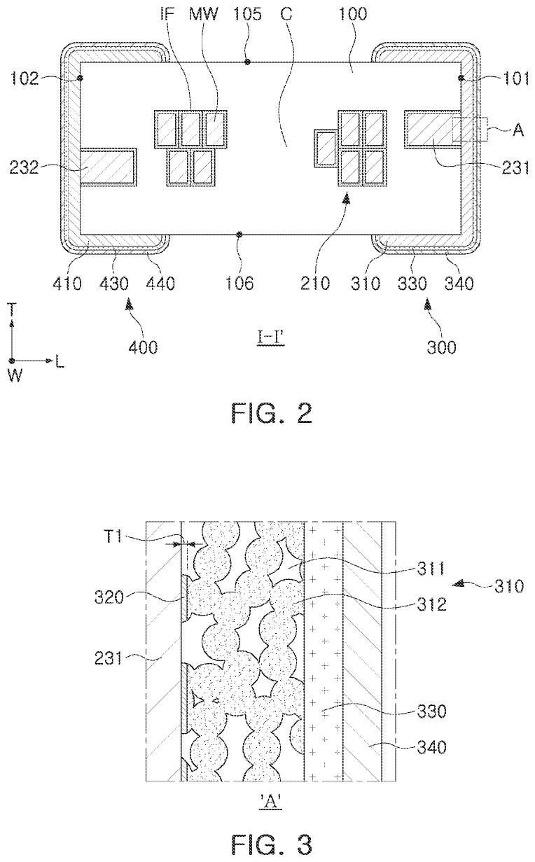

FIG. 1 is a view schematically illustrating a coil component according to an embodiment. FIG. 2 is a diagram schematically illustrating a cross-section taken along line I-I′ of FIG. 1.

Referring to FIGS. 1 and 2, a coil component 1000 according to an embodiment includes a body 100, a coil portion 200, an insulating film IF, and first and second external electrodes 300 and 400.

The body 100 forms the exterior of the coil component 1000 according to the present embodiment, and the coil portion 200 is embedded therein.

The body 100 may be formed in a hexahedral shape as a whole.

With reference to FIGS. 1 and 2, the body 100 may include a first surface 101 and a second surface 102 opposing each other in the longitudinal direction (L), a third surface 103 and a fourth surface 104 opposing each other in the width direction (W), and a fifth surface 105 and a sixth surface 106 opposing each other in the thickness direction (T). Each of the first to fourth surfaces 101, 102, 103, and 104 of the body 100 connects the fifth surface 105 and the sixth surface 106 of the body 100. The sixth surface 106 of the body 100 may be used as a mounting surface when the coil component 1000 according to the present embodiment is mounted on a mounting board such as a printed circuit board.

The body 100 may be formed such that the coil component 1000 according to an embodiment in which the first and second external electrodes 300 and 400 to be described later have been formed has a length of 2.5 mm, a width of 2.0 mm and a thickness of 1.0 mm, or a length of 1.6 mm, a width of 0.8 mm and a thickness of 0.8 mm, or a length of 1.0 mm, a width of 0.5 mm and a thickness of 0.5 mm, or a length of 0.8 mm, a width of 0.4 mm and a thickness of 0.65 mm, but the present disclosure is not limited thereto. On the other hand, since the above-described exemplary numerical values for the length, width, and thickness of the coil component 1000 refer to numerical values that do not reflect process errors, it should be considered that the numerical values in the range that may be recognized as process errors are in the above-described exemplary numerical values.

Based on the optical microscope image or Scanning Electron Microscope (SEM) image of the longitudinal direction (L)-thickness direction (T) cross-section in the width direction (W) central portion of the coil component 1000, the length of the above-described coil component 1000 may refer to a maximum value among the respective dimensions of a plurality of line segments, which respectively connect two outermost boundary lines of the coil component 1000 facing each other in the longitudinal direction L illustrated in the cross-sectional image and which are parallel to the longitudinal direction L. Alternatively, the length of the coil component 1000 may indicate a minimum value among the dimensions of respective line segments which respectively connect two outermost boundary lines facing each other in the longitudinal direction (L) of the coil component 1000 illustrated in the cross-sectional image and which are parallel to the longitudinal direction (L). Alternatively, the length of the coil component 1000 may refer to at least three arithmetic mean values among respective dimensions of a plurality of line segments connecting two outermost boundary lines disposed in the longitudinal direction L of the coil component 1000 illustrated in the cross-sectional image and that are parallel to the longitudinal direction L. In this case, the plurality of line segments parallel to the longitudinal direction L may be equally spaced from each other in the thickness direction T, but the scope of the present disclosure is not limited thereto.

Based on the optical microscope or Scanning Electron Microscope (SEM) image of the longitudinal direction (L)-thickness direction (T) cross-section in the width direction (W) central part of the coil component 1000, the thickness of the above-described coil component 1000 may mean a maximum value among the dimensions of a plurality of respective line segments parallel to the thickness direction T while connecting the two outermost boundary lines facing in the thickness direction (T) of the coil component 1000 illustrated in the cross-sectional image, respectively. Alternatively, the thickness of the above-described coil component 1000 may indicate a minimum value among the dimensions of a plurality of respective line segments parallel to the thickness direction T while respectively connecting the two outermost boundary lines facing in the thickness direction (T) of the coil component 1000 illustrated in the cross-sectional image is connected. Alternatively, the thickness of the above-described coil component 1000 may indicate at least 3 more arithmetic mean values among respective dimensions of the plurality of line segments which connect the two outermost boundary lines facing in the thickness direction T of the coil component 1000 illustrated in the cross-sectional image and which are parallel to the thickness direction T. In this case, the plurality of line segments parallel to the thickness direction T may be equally spaced from each other in the longitudinal direction L, but the scope of the present disclosure is not limited thereto.

Based on the optical microscope or Scanning Electron Microscope (SEM) image of the longitudinal direction (L)-width direction (W) cross-section in the thickness direction (T) central portion of the coil component 1000, the width of the above-described coil component 1000 may indicate a maximum value among the dimensions of a plurality of respective line segments parallel to the width direction W while connecting the two outermost boundary lines facing each other in the width direction (W) of the coil component 1000 illustrated in the cross-sectional image. Alternatively, the width of the above-described coil component 1000 may indicate a minimum value among the dimensions of a plurality of respective line segments parallel to the width direction W while respectively connecting two outermost boundary lines facing in the width direction (W) of the coil component 1000 illustrated in the cross-sectional image. Alternatively, the width of the above-described coil component 1000 may indicate at least three or more arithmetic mean values among dimensions of the plurality of respective line segments parallel to the width direction W while respectively connecting two outermost boundary lines disposed in the width direction (W) of the coil component 1000 illustrated in the cross-sectional image. In this case, the plurality of line segments parallel to the width direction W may be equally spaced from each other in the length direction L, but the scope of the present disclosure is not limited thereto.

Alternatively, each of the length, width, and thickness of the coil component 1000 may be measured by a micrometer measurement method. The micrometer measurement method may be performed by setting the zero point with a micrometer with Gage Repeatability and Reproducibility (R&R), by inserting the coil component 1000 according to this embodiment between the tips of the micrometer, and turning the measuring lever of the micrometer to measure. On the other hand, in measuring the length of the coil component 1000 by the micrometer measurement method, the length of the coil component 1000 may mean a value measured once or may mean an arithmetic average of values measured a plurality of times. This may equally be applied to the width and thickness of the coil component 1000.

The body 100 may have a core C passing through the central portion of the coil portion 200 to be described later. The core (C) may be formed as the magnetic composite sheet fills the through-hole formed in the central portion of the coil portion 200, in forming the body 100 by laminating at least one magnetic composite sheet including magnetic powder and an insulating resin on the upper and lower portions of the coil portion 200, but the present disclosure is not limited thereto.

The body 100 may include magnetic powder particles and an insulating resin. In detail, the body 100 may be formed by laminating one or more magnetic composite sheets including an insulating resin and magnetic powder dispersed in the insulating resin. The magnetic powder particles of the body 100 may be a magnetic powder of a magnetic composite sheet.

The magnetic powder particles may be ferrite or a magnetic metal material.

Ferrite may be at least one of, for example, spinel-type ferrites such as Mg—Zn, Mn—Zn, Mn—Mg, Cu—Zn, Mg—Mn—Sr or Ni—Zn, hexagonal ferrites such as Ba—Zn-based, Ba—Mg-based, Ba—Ni-based, Ba—Co-based, and Ba—Ni—Co-based ferrites, Y-based garnet-type ferrites, and Li-based ferrites.

The magnetic metal material may include at least one selected from the group consisting of iron (Fe), silicon (Si), chromium (Cr), cobalt (Co), molybdenum (Mo), aluminum (Al), niobium (Nb), copper (Cu) and nickel (Ni). For example, magnetic powder particles of the magnetic metal material may be formed of at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr alloy powder, and Fe—Cr—Al alloy powder.

The magnetic powder particles of the magnetic metal material may be amorphous or crystalline. For example, the magnetic powder particles of the magnetic metal material may be an amorphous Fe—Si—B—Cr-based alloy, but is not necessarily limited thereto.

Each of the magnetic powder particles may have an average diameter of about 0.1 μm to 30 μm, but is not limited thereto. In this specification, the particle size or average diameter may mean a particle size distribution expressed as D90 or D50.

The body 100 may include two or more types of magnetic powder particles dispersed in the insulating resin. In this case, the different types of magnetic powder particles means that the magnetic powder particles dispersed in the insulating resin are distinguished from each other by any one of an average diameter, composition, crystallinity, and shape.

The insulating resin may include, but is not limited to, epoxy, polyimide, liquid crystal polymer, etc. alone or in combination.

The coil portion 200 is disposed inside the body 100 and expresses the characteristics of the coil component. For example, when the coil component 1000 of the present embodiment is used as a power inductor, the coil portion 200 stores an electric field as a magnetic field to maintain an output voltage, thereby stabilizing the power of the electronic device.

The coil portion 200 may be a winding type coil formed by winding a metal wire MW such as a copper wire of which the surface is coated with an insulating film IF in a spiral shape.

The coil portion 200 includes a winding portion 210 formed with at least one turn with respect to the core (C) as an axis, and first and second lead-out portions 231 and 232 respectively extended from both ends of the winding portion 210 and exposed to the first and second surfaces of the body 100, respectively. The first lead-out portion 231 extends from one end of the winding portion 210 and is exposed to the first surface 101 of the body 100, and the second lead-out portion 232 extends from the other end of the winding portion 210 and is exposed to the second surface 102 of the body 100.

The winding portion 210 may be formed by winding the metal wire MW such as a copper wire having a surface coated with an insulating film IF in a spiral shape. As a result, in the cross-section of the component (for example, the L-T cross-section as in FIG. 2), all surfaces of each turn of the winding portion 210 (corresponding to a total of four line segments constituting the upper and lower surfaces of each turn and two sides opposing each other, in the L-T cross-section of FIG. 2) has a form covered with an insulating film IF. The winding portion 210 may be composed of at least one layer. Each layer of the winding portion 210 is formed in a planar spiral, and may have at least one number of turns.

The first and second lead-out portions 231 and 232 may be integrally formed with the winding portion 210. By winding the metal wire MW such as a copper wire coated with an insulating film IF in a spiral shape, the winding portion 210 and the first and second lead-out portions 231 and 232 may be integrally formed.

The metal wire MW may be formed of a conductive material, such as copper (Cu), aluminum (Al), silver (Ag), tin (Sn), gold (Au), nickel (Ni), lead (Pb), titanium (Ti), chromium (Cr), molybdenum (Mo) or alloys thereof, but is not limited thereto.

The insulating layer IF may include an insulating material such as enamel, paralin, epoxy, or polyimide. The insulating layer IF may be formed of two or more layers. As a non-limiting example, the insulating film IF may include a coating layer in contact with the metal wire MW, and a fusion layer formed on the coating layer. The fusion layer may be combined with the fusion layer of the metal wire MW constituting turns adjacent to each other by heat and pressure after winding the metal wire MW as a wire in a coil shape. In the case of winding the metal wire MW including the insulating film IF having such a structure, the fusion layers of a plurality of turns of the winding portion 210 may be fused to each other and integrated.

On the other hand, although FIGS. 1 and 2 illustrate that the coil portion 200 of the present embodiment is an alpha winding, the scope of the present embodiment is not limited thereto, and a coil as an edge-wise winding may also belong to this embodiment.

The first and second external electrodes 300 and 400 include the first electrode layers 310 and 410, the second electrode layers 330, 340; 430, 440 disposed on the first electrode layers 310 and 410, the lead-out portion, and intermetallic compounds (320 and 420 in FIG. 3) disposed between the 231 and 232 and the first electrode layers 310 and 410.

The first and second external electrodes 300 and 400 are spaced apart from each other on the body 100 to be connected to the coil portion 200. The first external electrode 300 is connected while being in contact with the first lead-out portion 231 of the coil portion 200 disposed on the first surface 101 of the body 100 and exposed to the first surface 101 of the body 100. The second external electrode 400 is connected while being in contact with the second lead-out portion 232 of the coil portion 200 disposed on the second surface 102 of the body 100 and exposed to the second surface 101 of the body 100.

On the other hand, the first and second external electrodes 300 and 400 are different only in the connection relationship with the first and second lead-out portions 231 and 232 and the positions formed on the body 100, respectively, while the first and second external electrodes 300 and 400 include the first and second electrode layers 310, 330, 340, 410, 430 and 440, and intermetallic compounds 320 and 420 equally. Accordingly, in the following description of the first and second external electrodes 300 and 400, the first external electrode 300 disposed on the first surface 101 of the body 100 will be mainly described, and the second external electrode A description of 400 will be omitted. A description to be given later of the first external electrode 300 may be equally applied to the second external electrode 400.

FIG. 3 is a diagram schematically illustrating enlarged area A of FIG. 2.

As illustrated in FIG. 3, the first external electrode 300 includes a first electrode layer 310 and an intermetallic compound 320, and may further include second electrode layers 330 and 340. The first electrode layer 310 includes a base resin 311 and a conductive connection portion 312.

The first electrode layer 310 covers the first surface 103 of the body 100. The first electrode layer 310 serves to electrically and mechanically bond the body 100 and the second electrode layers 330 and 340, and serves to absorb tensile stress generated in a mechanical or thermal environment when the coil component 1000 according to the present embodiment is mounted on a mounting board, thereby preventing cracks from occurring.

The first electrode layer 310 may be formed by applying a conductive paste in which a base resin and a plurality of metal powder particles are dispersed to the first surface 101 of the body 100, and drying and curing the applied conductive paste. After the above process, the base resin of the conductive paste may become the base resin 311 of the first electrode layer 310, and the plurality of metal powder particles of the conductive paste may become a conductive connection portion 312 of the first electrode layer 310 by the pressure and heat in the process. In detail, the conductive paste may include, as a plurality of metal powder particles, powder particles of a low-melting-point metal (for example, tin (Sn), or tin (Sn)-bismuth (Bi) alloy, tin (Sn)-lead (Pb) alloy, tin (Sn)-copper (Cu) alloy, tin (Sn)-silver (Ag) alloys and alloys containing tin (Sn) such as tin (Sn)-silver (Ag)-copper (Cu) alloys) having a melting point lower than the curing temperature of the base resin; and powder particles of a high-melting-point metal (e.g., copper, silver, or the like) having a melting point higher than the melting point of the low-melting-point metal powder particles. The low-melting-point metal powder particles are melted by the pressure and heat in the above-described process and react with the metal of the high-melting-point metal powder particles to form the conductive connection portion 312.

The base resin 311 serves to mechanically bond between the body 100 and the second electrode layers 330 and 340. The base resin 311 may include a thermosetting resin having electrical insulation properties. The thermosetting resin may be, for example, an epoxy resin, but the present disclosure is not limited thereto.

For the above reasons, the conductive connection portion 312 may include a metal of low-melting-point metal powder particles and a metal of high-melting-point metal powder particles together. As a non-limiting example, the conductive connection portion 312 may be formed of an alloy including two or more selected from tin (Sn), lead (Pb), indium (In), copper (Cu), silver (Ag), and bismuth (Bi). As a non-limiting example, the conductive connection portion 312 may include at least one of copper (Cu) and silver (Ag) and tin (Sn). For example, when the aforementioned conductive paste includes silver (Ag) powder and tin (Sn) powder, the conductive connection portion 312 may include Ag₃Sn.

The conductive connection portions 312 may be present in a randomly dispersed form in the base resin 311, but may be included in the first electrode layer 310 in a form connected to each other.

The intermetallic compound (IMC) is disposed on the exposed surface of the first lead-out portion 231 exposed to the first surface 101 of the body 100 and is in contact with the conductive connection portion 312. The intermetallic compound 320 serves to connect the first lead-out portion 231 and the conductive connection portion 312. Accordingly, the intermetallic compound 320 serves to improve the electrical and mechanical bonding between the first lead-out portion 231 and the conductive connection portion 312 and to reduce the contact resistance between the first lead-out portion 231 and the conductive connection portion 312 (or the contact resistance between the coil portion and the first external electrode).

The intermetallic compound 320 may be disposed only between the exposed surface of the first lead-out portion 231 exposed to the first surface 101 of the body 100 and the first electrode layer 310. In detail, the intermetallic compound 320 may be disposed only at the interface between the exposed surface of the first lead-out portion 231 exposed to the first surface 101 of the body 100 and the first electrode layer 310. Therefore, for the above reasons, the intermetallic compound 320 is not disposed in a region in which the first lead-out portion 231 is not exposed, in the first surface 101 of the body 100, and the first electrode layer 310 is disposed in the corresponding area and is in contact with the first surface 101 of the body 100. As a result, the bonding force between the body 100 and the first electrode layer 310 may increase. For example, the body 100 includes an insulating resin, and since the first electrode layer 310 in contact with the first surface 101 of the body 100 has the same polymer material as the body 100, the bonding force between the body 100 and the first electrode layer 310 may increase.

The intermetallic compound 320 may be formed by a reaction between a metal component of the low-melting-point metal particle included in the conductive paste for forming the first electrode layer and a metal component of the first lead-out portion 231. In detail, the low-melting-point metal powder particles included in the conductive paste for forming the first electrode layer are melted by heat and pressure in the process of curing the conductive paste for forming the first electrode layer, and reacts with the metal component of the first lead-out portion 231, thereby forming an intermetallic compound 320. As a result, the intermetallic compound 320 has a form that exists only at the interface between the exposed surface of the first lead-out portion 231 exposed to the first surface 101 of the body 100 and the first electrode layer 310.

The intermetallic compound 320 may include the metal of the low-melting-point metal particle and the metal of the first lead-out portion 231 for the above-mentioned reasons. As a non-limiting example, the intermetallic compound 320 may be formed of two or more alloys selected from tin (Sn), lead (Pb), indium (In), copper (Cu), silver (Ag), nickel (Ni), and bismuth (Bi). When the first lead-out portion 231 is formed of copper (Cu), the intermetallic compound 320 may include a Cu—Sn-based alloy. On the other hand, that the intermetallic compound 320 includes a Cu—Sn-based alloy means that the alloy is an alloy composed of Cu and Sn, or an alloy containing Cu and Sn and containing other metals or non-metal elements.

The thickness T1 of the intermetallic compound 320 may be 1.0 μm or more. When the thickness of the intermetallic compound 320 is less than 1.0 μm, defects may occur in lead heat resistance evaluation, as will be described later.

In this case, the thickness T1 of the intermetallic compound 320 may be 10 μm or less. When the thickness of the intermetallic compound 320 is greater than 10 μm, as will be described later, cracks may occur in the intermetallic compound 320, so that the electrical connectivity between the coil portion 200 and the first external electrode 300 is reduced.

In this case, the thickness T1 of the intermetallic compound 320 may be 3 μm or less. When the thickness of the intermetallic compound 320 is greater than 3 μm, the second electrode layer 330, 340 may not be sufficiently formed in plating the second electrode layer 330, 340 to be described later on the first electrode layer 310 by plating. Due to this, the mechanical coupling force between the coupling member such as solder and the first external electrode 300 may be reduced.

On the other hand, the intermetallic compound 320, for example, as illustrated in FIG. 3, the first lead-out portion 231 and the first electrode layer 310 in the longitudinal-thickness direction cross-section (L-T cross-section) taken from the central portion in the width direction. The boundary area of the liver may be measured by scanning an image with a scanning electron microscope (SEM). For example, in the image, the first and second lead-out portion 231, the intermetallic compound 320 and the first electrode layer 310 may be distinguished by contrast due to the difference in the type of metal element, the difference in the content of a specific metal element, and whether or not a polymer material is included. The layer disposed between the first lead-out portion 231 and the first electrode layer 310 may be determined as the intermetallic compound 320. Alternatively, by the contrast illustrated in the image, the first lead-out portion 231 and the intermetallic compound 320 that do not contain a polymer material and the first electrode layer 310 that contains a polymer material may be distinguished, and EDS component analysis of the region (the first lead-out portion 231 and the intermetallic compound 320) not containing the polymer material is performed; and a region in which the mass ratio (wt %) of the metal component (e.g., tin (Sn)) of the aforementioned low-melting-point metal powder particles is 10 wt % or more may be determined as the intermetallic compound 320.

In addition, the thickness (T1) of the intermetallic compound 320 may be obtained by measuring the dimension along the longitudinal direction (L) of the intermetallic compound (320) determined in the image at least three times along the thickness direction (T) and by performing the arithmetic mean thereof. The plurality of measurement points along the thickness direction T may be equally spaced along the thickness direction T, but are not limited thereto.

The intermetallic compound 320 may be disposed in the form of a plurality of islands on the exposed surface of the first lead-out portion 231. For example, the intermetallic compound 320 may be disposed in a plurality of spaced apart from each other on the exposed surface of the first lead-out portion 231. In addition, the plurality of islands may be formed in the form of a layer.

The second electrode layers 330 and 340 are disposed on the first electrode layer 310 to contact the conductive connection portion 312. As a non-limiting example, each of the second electrode layers 330 and 340 may be a plating layer formed by electroplating. The second electrode layers 330 and 340 may have, for example, a structure in which a nickel plating layer 330 and a tin plating layer 340 are sequentially stacked. The nickel plating layer 330 is in contact with the conductive connection portion 312 of the first electrode layer 310 and the base resin 311.

The first electrode layer 310 may cover the first surface 101 of the body 100, and extend to at least a portion of each of the third to sixth surfaces 103, 104, 105 and 106 of the body 100 connected to the first surface 101 of the body 100. The second electrode layers 330 and 340 may cover the first electrode layer 310 or may be disposed only in a partial region of the first electrode layer 310.

Tables 1 to 3 are evaluations of various properties according to the average thickness change of the intermetallic compound.

Examples 1 to 15 of Tables 1 to 3, while making the average thickness of the first electrode layer the same, to change the thickness of the intermetallic compound, the composition and content of the metal powder particles in the conductive paste for forming the first electrode layer are adjusted or, the conductive paste curing temperature was adjusted.

Except for the above differences, all other conditions are the same in Examples 1 to 15.

Table 1 illustrates the results of the lead heat resistance evaluation of the external electrode according to the change in the average thickness of the intermetallic compound 320. In the case of lead heat resistance evaluation, by performing a lead heat resistance test at a temperature of 270° C. and a time of 10 seconds, Rdc change rate of 10% or less compared to before the lead heat resistance test was evaluated as pass (O), and Rdc change rate of more than 10% was evaluated as fail (X).

TABLE 1

| | | Lead heat resistance |
|---|---|---|
| | Average thickness (μm) | evaluation |
| #1 | 0.34 | X |
| #2 | 0.53 | X |
| #3 | 0.78 | X |
| #4 | 0.9 | X |
| #5 | 1.10 | O |
| #6 | 1.76 | O |
| #7 | 2.14 | O |
| #8 | 2.30 | O |
| #9 | 2.45 | O |
| #10 | 2.73 | O |
| #11 | 3.38 | O |
| #12 | 4.97 | O |
| #13 | 5.56 | O |
| #14 | 8.01 | O |
| #15 | 13.77 | O |

Referring to Table 1, each of Examples 1 to 4, in which the average thickness of the intermetallic compound 320 is less than 1 μm, was defective in lead heat resistance evaluation. In each of Examples 5 to 15, in which the average thickness of the intermetallic compound 320 was 1 μm or more, no defects occurred in the evaluation of lead heat resistance. Therefore, in this embodiment, the average thickness of the intermetallic compound 320 is 1 μm or more, so that the lead heat resistance property may be improved, and the change in Rdc of the component may be brought within a certain range.

Table 2 illustrates whether cracks exist in the intermetallic compound according to the change in the average thickness of the intermetallic compound 320. The presence of cracks in the intermetallic compound was determined by visual inspection based on the SEM image of the cross-section of the component to determine the presence or absence of cracks (O, X).

TABLE 2

| | Average thickness (μm) | Cracks |
|---|---|---|
| #1 | 0.34 | X |
| #2 | 0.53 | X |
| #3 | 0.78 | X |
| #4 | 0.9 | X |
| #5 | 1.10 | X |
| #6 | 1.76 | X |
| #7 | 2.14 | X |
| #8 | 2.30 | X |
| #9 | 2.45 | X |
| #10 | 2.73 | X |
| #11 | 3.38 | X |
| #12 | 4.97 | X |
| #13 | 5.56 | X |
| #14 | 8.01 | X |
| #15 | 13.77 | 0 |

Referring to Table 2, in each of Examples 1 to 14 in which the average thickness of the intermetallic compound 320 is 10 μm or less, cracks did not occur in the intermetallic compound 320, but the average thickness of the intermetallic compound 320 was greater than 10 μm in Example 15, which was larger than μm, cracks occurred in the intermetallic compound 320. In the present embodiment, by limiting the average thickness of the intermetallic compound 320 to 10 μm or less, the occurrence of cracks in the intermetallic compound 320 is reduced to minimize the change in Rdc. In addition, it is possible to relatively reduce the resistance between the coil portion 200 and the first external electrode 300.

Table 3 illustrates the results of the solderability test according to the change in the average thickness of the intermetallic compound 320. The solder wettability test evaluates the wettability between the outermost layer (finishing layer) of the external electrode of the component and the solder used when the component is mounted on the mounting board, and solder wettability is proportional to the formation area of the second metal layer, which is the outermost layer of the external electrode. For example, the high wettability of the solder means that the second electrode layer, which is the finishing layer of the external electrode, covers the exposed surface of the first electrode layer at a relatively high ratio.

The solder wettability test was performed, with the formation height of the solder fillet as a reference, after solder is interposed between the component in which the second metal layer of the external electrode (in the case of including the formation of an Sn plating layer) is formed, and the pad of the mounting board, and solder reflow is performed. For example, when the height of the solder fillet after solder reflow is ⅓ or more of the total thickness of the component including the external electrode, it was determined as pass (O), and when the height of the solder fillet was less than ⅓ of the total thickness of the component including the external electrode, it was judged as fail (X).

TABLE 3

| | Average thickness (μm) | Solderability Test |
|---|---|---|
| #1 | 0.34 | O |
| #2 | 0.53 | O |
| #3 | 0.78 | O |
| #4 | 0.9 | O |
| #5 | 1.10 | O |
| #6 | 1.76 | O |
| #7 | 2.14 | O |
| #8 | 2.30 | O |
| #9 | 2.45 | O |
| #10 | 2.73 | O |
| #11 | 3.38 | X |
| #12 | 4.97 | X |
| #13 | 5.56 | X |
| #14 | 8.01 | X |
| #15 | 13.77 | X |

Referring to Table 3, in each of Examples 1 to 10, in which the average thickness of the intermetallic compound 320 is 3 μm or less, a defect did not occur in the solderability test, and in each of Examples 11 to 15, in which the average thickness of the intermetallic compound 320 was greater than 3 μm, a defect occurred in the solderability test. This means that as the average thickness of the intermetallic compound 320 increases, the metal powder particles in the conductive paste for forming the first electrode layer are consumed to form the intermetallic compound 320, and as a result, in forming the second electrode layer by plating the surface of the first electrode layer, it is considered that this is because the formation area of the second electrode layer is relatively low.

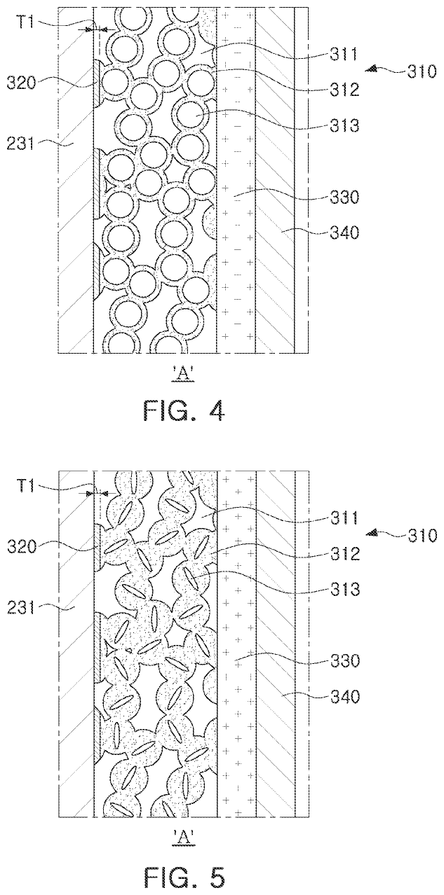

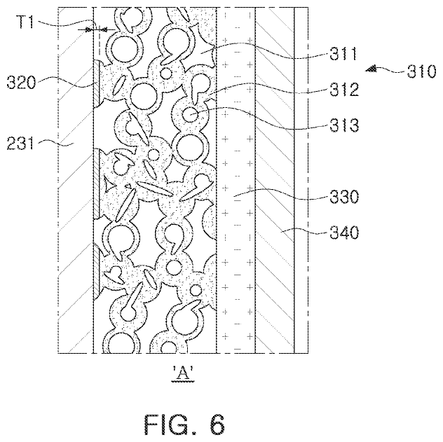

FIG. 4 is a diagram illustrating enlarged area corresponding to area A of FIG. 2 for a modified example of the coil component illustrated in FIG. 1. FIG. 5 is a diagram illustrating enlarged area corresponding to area A of FIG. 2 for another modified example of the coil component illustrated in FIG. 1. FIG. 6 is a view illustrating enlarged area corresponding to area A of FIG. 2 for another modified example of the coil component illustrated in FIG. 1.

Referring to FIGS. 4 to 6, in the modified examples of the present embodiment, the first electrode layer 310 may further include a plurality of metal powder particles 313. The plurality of metal powder particles 313 may be disposed in the first electrode layer 310 in a form at least partially covered by the conductive connection portion 312.

In the curing process for forming the first electrode layer 310, the plurality of metal powder particles 313 may be formed of a low-melting-point metal particle in which at least a portion of the high-melting-point metal particle included in the conductive paste for forming the first electrode layer is melted. It may not react and may remain.

The metal powder particles 313 may include at least one of nickel (Ni), silver (Ag), silver (Ag) coated copper (Cu), tin (Sn) coated copper (Cu), and copper (Cu).

The metal powder particles 313 included in the first electrode layer 310 may be formed only in a spherical shape as illustrated in FIG. 4 or only in a flake shape as illustrated in FIG. 5, or as illustrated in FIG. 6, may be of a mixed type of spherical and flake types.

The average size of the metal powder particles 313 may be in a range from 0.2 μm to 20 μm. On the other hand, the average size of the metal powder particles 313 may indicate any one of the diameters of the plurality of metal powder particles 313 illustrated in the image, based on the optical micrograph or SEM image of the L-T cross-section taken from the central portion in the W direction. The diameter may mean a maximum dimension among a plurality of arbitrary line segments passing through the single metal particle 313. Alternatively, the average size of the metal powder particles 313 may be an arithmetic average of at least three or more diameters from among the plurality of metal powder particles 313 illustrated in the picture, respectively. Alternatively, the average size of the metal powder particles 313 may refer to the diameter of the virtual circle, based on any one of the plurality of metal powder particles 313 illustrated in the photo, assuming a circle having the same area as the cross-sectional area of the metal particle 313. Alternatively, the average size of the metal powder particles 313 may be an arithmetic mean of diameters obtained by assuming that at least three or more of the plurality of metal powder particles 313 illustrated in the photo are the above-described iso-area circles, respectively.

On the other hand, although not illustrated, the coil component 1000 according to the present embodiment is disposed on at least a portion of each of the first to sixth surfaces 101, 102, 103, 104, 105 and 106 of the body 100. It may further include an insulating layer. For example, the surface insulating layer may be disposed on at least a portion of the regions in which the first and second external electrodes 300 and 400 are not formed among the first to sixth surfaces 101, 102, 103, 104, 105 and 106 of the body 100. As another example, the surface insulating layer may cover regions corresponding to the first to fifth surfaces 101, 102, 103, 104, 105 of the body 100 among the outer surfaces of the components formed by the body 100 and the first and second external electrodes 300 and 400, and may be formed in a region in which the first and second external electrodes 300 and 400 are not formed among the sixth surface 106 of the body 100.

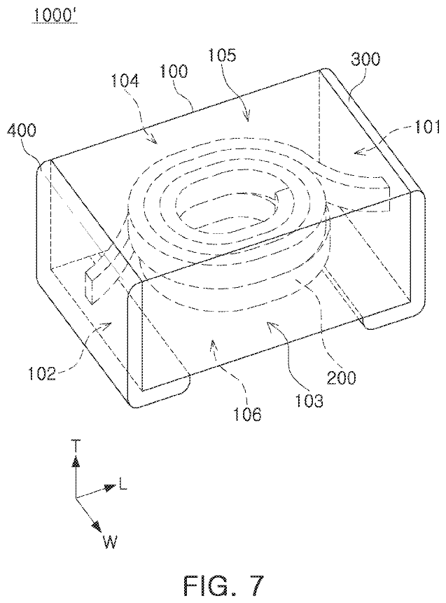

FIG. 7 is a view schematically illustrating a modified example of an external electrode of the coil component illustrated in FIG. 1. Referring to FIG. 7, the first external electrode 300 of the coil component 1000′ according to a modification of the present embodiment covers the first surface 101 of the body 100, and extends to the sixth surface 106. The second external electrode 400 covers the second surface 102 of the body 100 and extends to the sixth surface 106 of the body 100. On the sixth surface 106 of the body 100, the first and second external electrodes 300 and 400 are spaced apart from each other. For example, in this modified example, the first and second external electrodes 300 and 400 are formed in an L shape.

For example, each of the first electrode layers 310 and 410 and the second electrode layers (330, 340; 430, 440) may be formed on position of formation of the first and second external electrodes 300 and 400. As another example, the first electrode layers 310 and 410 are formed on the formation positions of the first and second external electrodes 300 and 400 described above, and the second electrode layers (330, 340; 430, 440) may be disposed only in a region disposed on the sixth surface 106 of the body 100 among the first electrode layers 310 and 410.

In this modified example, the volume occupied by the first and second external electrodes 300 and 400 in the entire component may be reduced, so that the volume of the body 100 may be increased when a component having the same size is assumed. For example, the volume of the magnetic material based on the components of the same size may increase.

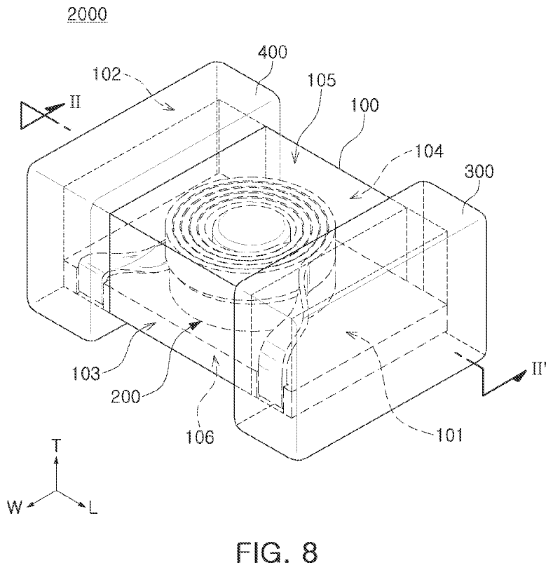

FIG. 8 is a view schematically illustrating a coil component according to another embodiment. 9 is a view schematically illustrating a mold portion applied to the coil component illustrated in FIG. 8. FIG. 10 is a view schematically illustrating a cross-section taken along line II-II′ of FIG. 8. 11 is a diagram schematically illustrating enlarged area B of FIG. 10.

Comparing FIGS. 1 and 2 and FIGS. 8 to 10, the coil component 2000 according to the present embodiment has a structure of the body 100 when compared with the coil component 1000 according to the embodiment, and the structure of the first and second lead-out portions 231 and 232 are different from each other. Therefore, in describing this embodiment, only the body 100 and the first and second lead-out portions 231 and 232 different from the coil component 1000 according to the embodiment will be described. For the rest of the configuration of the present embodiment, the description in one embodiment may be applied as it is. In addition, also in this embodiment, modifications of an embodiment may be applied as it is.

The body 100 applied to the coil component 2000 according to the present embodiment includes a mold portion 110 and a cover part 120. The side surfaces of the mold portion 110 and the cover part 120 constitute the first to fifth surfaces 101, 102, 103, 104, and 105 of the body 100, and the other surface of the mold portion 110 (the lower surface of the mold portion 110 in the direction of FIGS. 8 to 10) constitutes the sixth surface 106 of the body 100. Hereinafter, the other surface of the mold portion 110 and the sixth surface 106 of the body 100 are used in the same meaning.

The mold portion 110 has a support part 111 having one surface and the other surface opposing each other, and a core C protruding from one surface of the support part 111. The support part 111 supports the coil portion 200 disposed on one surface of the support part 111. A core C is disposed to protrude from one surface of the support 111. The core C is disposed in the central portion of one surface of the support 111 and penetrates the coil 200.

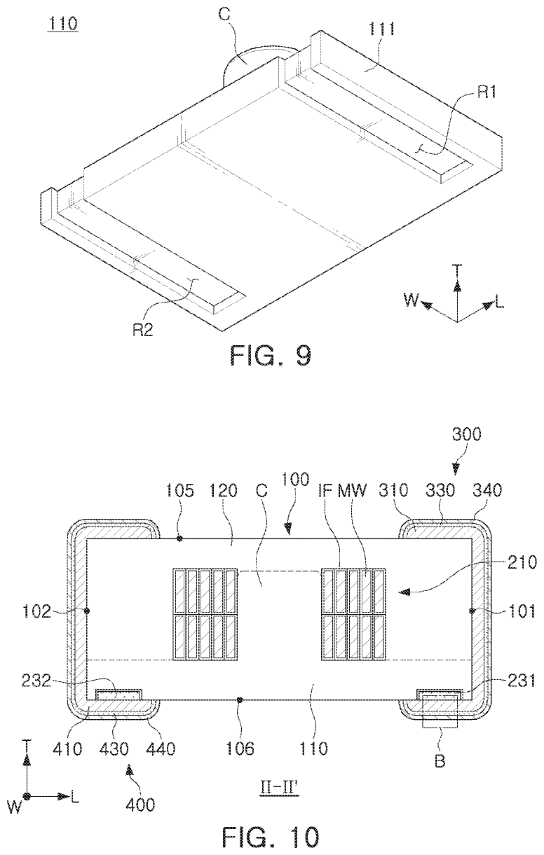

Referring to FIG. 9, on the other surface of the support part 111 and one side connecting the one surface and the other surface of the support part 111, groove portions R and R′ in which first and second lead-out portions 231 and 232 extending from both ends of the winding portion 210 are disposed are formed. The grooves R and R′ are formed in a shape corresponding to the first and second lead-out portions 231 and 232. On the other hand, the grooves R and R′ may be formed in the process of forming the mold portion 110 with a mold or may be formed in the mold portion 110 in the process of pressing the cover part 120. As another example, the first and second lead-out portions 231 and 232 may pass through the mold portion 110 and be exposed to the other surface of the mold portion 110.

For example, the mold portion 110 may be formed using a mold having an internal space corresponding to the shape of the support part 111 and the core C. The mold portion 110 may be formed by filling magnetic powder particles in the mold. As another example, the mold portion 110 may be formed by filling the mold with a composite material including magnetic powder particles and an insulating resin. A process of applying high temperature and high pressure to the magnetic powder particles or composite material in the mold may be additionally performed, but the present disclosure is not limited thereto. The support 111 and the core C may be integrally formed by the process using the above-described mold, so that a boundary may not be formed between them.

The cover part 120 is disposed on one surface of the mold portion 110 to cover the coil portion 200. The cover part 120 may be formed by disposing a magnetic composite sheet in which magnetic powder particles are dispersed in an insulating resin on the mold unit 110 and the coil portion 200 and then heating and pressing. Through the above process, the mold portion 110 and the cover part 120 may be integrated with each other so that the boundary between them is not distinguished without a separate treatment, but the scope of the present disclosure is not limited thereto.

The first and second lead-out portions 231 and 232 applied to this embodiment are exposed together as the sixth surface 106 of the body 100, unlike in the embodiment. For example, the first and second lead-out portions 231 and 232 may be disposed in the groove portions R and R′ of the mold portion 110, and be exposed on the sixth surface 106 of the body 100 to be spaced apart from each other.

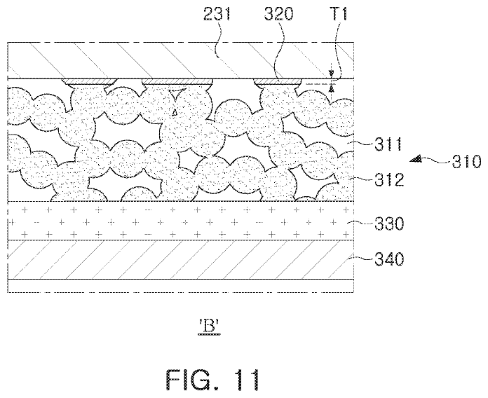

On the other hand, as illustrated in FIG. 11, in this embodiment, the intermetallic compound 320 may be disposed at an interface between the exposed surface of the first lead-out portion 231 exposed to the sixth surface 106 of the body 100 and the first electrode layer 310.

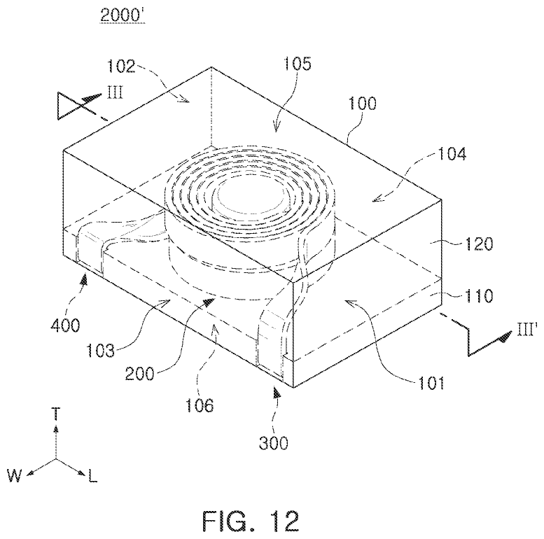

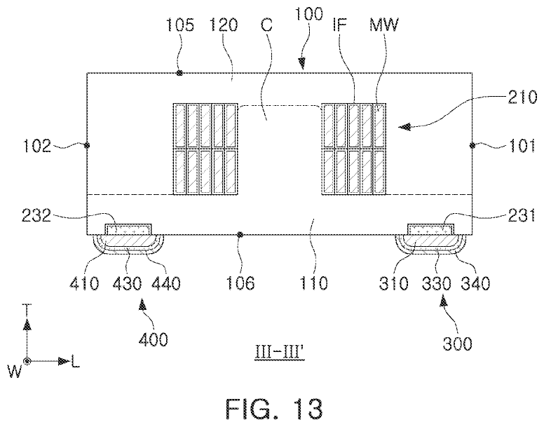

FIG. 12 is a view schematically illustrating a modified example of an external electrode of the coil component illustrated in FIG. 11.

Referring to FIG. 12, the first and second external electrodes 300 and 400 of the coil component 2000′ according to a modified example of the present embodiment are spaced apart from each other on the sixth surface 106 of the body 100, and is not disposed on the first to fifth surfaces 101, 102, 103, 104, 105 of the body 100. Each of the first and second external electrodes 300 and 400 may have a shape extending along the W direction from the sixth surface 106 of the body 100. For example, in the present embodiment, since each of the first and second lead-out portions 231 and 232 has a shape extending along the W direction from the sixth surface 106 of the body 100, each of the first and second external electrodes 300 and 400 connected to the exposed first and second lead-out portions 231 and 232 also has a shape extending along the W direction from the sixth surface 106 of the body 100.

In this modified example, the volume occupied by the first and second external electrodes 300 and 400 in the entire component may be reduced, so that the volume of the body 100 may be increased when a component having the same size is assumed. For example, it is possible to increase the volume of the magnetic material based on the components of the same size.

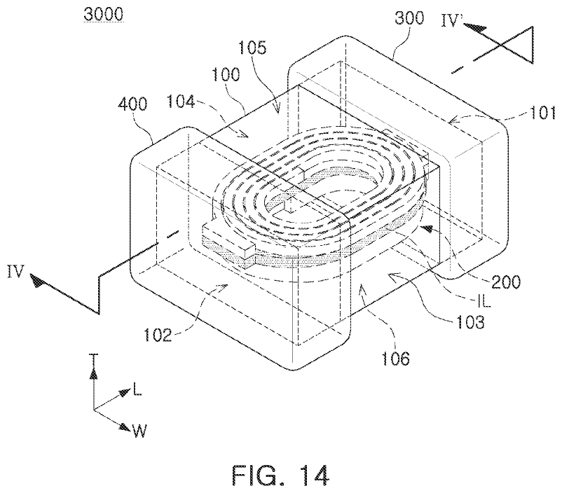

FIG. 14 is a view schematically illustrating a coil component according to another embodiment. 15 is a view schematically illustrating a cross-section taken along line IV-IV′ of FIG. 14.

Comparing FIGS. 1 and 2 and FIGS. 14 to 15, a coil component 3000 according to this embodiment has a difference when compared with the coil component 1000 according to the embodiment, in that a coil portion 200 is different, and a substrate IL is further included. Therefore, in describing the present embodiment, only the coil portion 200 and the substrate IL different from the coil component 1000 according to the embodiment will be described. For the rest of the configuration of the present embodiment, the description in one embodiment may be applied as it is. In addition, also in this embodiment, modifications of an embodiment may be applied as it is.

The substrate IL is disposed in the body 100. The substrate IL is configured to support the coil portion 200. The substrate IL may be formed of an insulating material including at least one of a thermosetting insulating resin such as an epoxy resin, a thermoplastic insulating resin such as polyimide, and a photosensitive insulating resin. Alternatively, the substrate IL may be formed of an insulating material in which a reinforcing material such as glass fiber or an inorganic filler is impregnated into at least one resin described above. By way of example, the substrate IL may be formed of an insulating material such as Copper Clad Laminate (CCL), an insulating material (Unclad CCL) from which the copper foil has been removed from the copper clad laminate, prepreg, Ajinomoto Build-up Film (ABF), FR-4, Bismaleimide Triazine (BT) film, Photo Imageable Dielectric (PID) film, or the like, but the material thereof is not limited thereto.

As the inorganic filler, at least one selected from the group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), carbonic acid Calcium (CaCO₃), magnesium carbonate (MgCO₃), magnesium oxide (MgO), boron nitride (BN), aluminum borate (AlBO₃), barium titanate (BaTiO₃) and calcium zirconate (CaZrO₃) may be used.

When the substrate IL is formed of an insulating material including a reinforcing material, the substrate IL may provide greater rigidity. When the substrate IL is formed of an insulating material that does not contain glass fibers, it may be advantageous because the volume of the coil portion 200 may be increased within the same size of the body 100. When the substrate IL is formed of an insulating material including a photosensitive insulating resin, the number of processes for forming the coil portion 200 is reduced, which is advantageous in reducing production costs and allows the formation of fine vias.

The coil portion 200 includes first and second coil patterns 211 and 212, first and second lead-out portions 231 and 232, and vias.

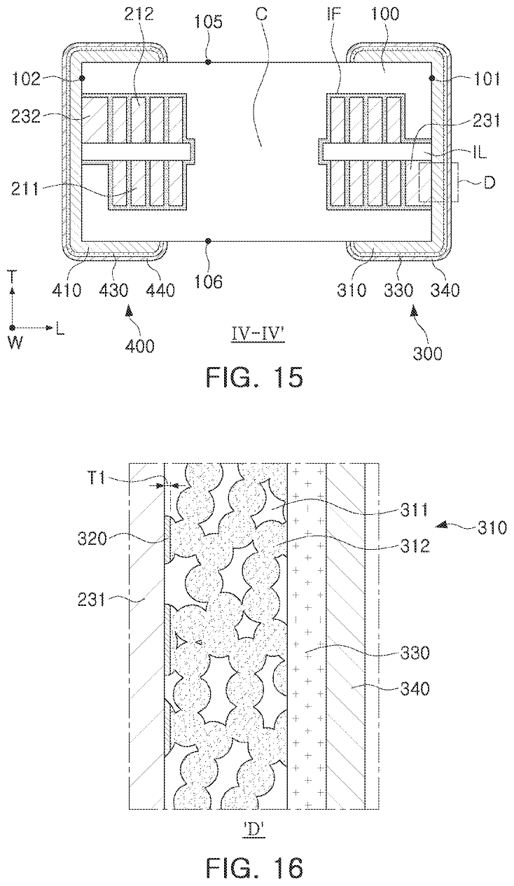

In detail, based on the directions of FIGS. 14 and 15, a first coil pattern 211 and a first lead-out portion 231 are disposed on a lower surface of the substrate IL facing the sixth surface 106 of the body 100, and the second coil pattern 212 and the second lead-out portion 232 are disposed on the upper surface of the substrate IL facing the lower surface of the substrate IL. On the lower surface of the substrate IL, the first coil pattern 211 is contacted with the first lead-out portion 231. On the upper surface of the substrate IL, the second coil pattern 212 is connected to the second lead-out portion 232 and the via passes through the substrate IL to contact and be connected to inner ends of each of the first coil pattern 211 and the second coil pattern 212. Therefore, the coil portion 200 may function as a single coil as a whole.

Each of the first coil pattern 211 and the second coil pattern 212 may be in the form of a plane spiral in which at least one turn is formed about the core C as an axis. For example, the first coil pattern 211 may form at least one turn on the lower surface of the substrate IL with the core C as an axis.

The first and second lead-out portions 231 and 232 are exposed to the first and second surfaces 101 and 102 of the body 100, respectively. For example, the first lead-out portion 231 is exposed to the first surface 101 of the body 100, respectively, and the second lead-out portion 232 is exposed to the second surface 102 of the body 100.

At least one of the first and second coil patterns 211 and 212 and the first and second lead-out portions 231 and 232 may include at least one conductive layer.

For example, when forming the second coil pattern 212 and the second lead-out portion 232 on the upper surface of the substrate IL by plating based on the directions of FIGS. 14 and 15, each of the second coil pattern 212 and the second lead-out portion 232 may include a seed layer such as an electroless plating layer and an electrolytic plating layer. In this case, the electroplating layer may have a single-layer structure or a multi-layer structure. The electroplating layer having a multi-layer structure may be formed in a conformal film structure in which one electroplating layer is covered by the other electroplating layer, and may be formed in a shape in which another electroplating layer is laminated on only one surface of one electroplating layer. The seed layer of the second coil pattern 212 and the seed layer of the second lead-out portion 232 may be integrally formed so that a boundary may not be formed between them, but is not limited thereto. The electrolytic plating layer of the second coil pattern 212 and the electrolytic plating layer of the second lead-out portion 232 are integrally formed so that a boundary may not be formed between them, but the present disclosure is not limited thereto.

Each of the first and second coil patterns 211 and 212, the first and second lead-out portions 231 and 232 and the vias may be formed of a conductive material such as copper (Cu), aluminum (Al), silver (Ag), tin (Sn), gold (Au), nickel (Ni), lead (Pb), titanium (Ti), chromium (Cr), molybdenum (Mo) or alloys thereof, but is not limited thereto. For example, the first coil pattern 211 may include a seed layer including copper (Cu) in contact with the substrate IL, and an electrolytic plating layer disposed on the seed layer and including copper (Cu). The scope of the invention is not limited thereto.

The insulating film IF is disposed between the coil portion 200 and the body 100. The insulating layer IF may be formed by at least one of a vapor deposition method and a film lamination method. On the other hand, in the latter case, the insulating film IF may be a permanent resist in which the plating resist used in plating the coil portion 200 on the substrate IL remains in the final product, but is not limited thereto. The insulating layer IF may include an insulating material such as paraline, epoxy, or polyimide.

On the other hand, as illustrated in FIG. 16, also in this embodiment, the metal at the interface between the exposed surface of the first lead-out portion 231 exposed to the first surface 101 of the body 100 and the first electrode layer 310 is intermetallic compound 320.

As set forth above, according to an embodiment, the bonding force between the body and the external electrode may be increased.

In addition, according to an embodiment, the component characteristics may be improved by reducing contact resistance between the lead-out portion and the external electrode.

While this disclosure includes detailed examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A coil component comprising:
a body including magnetic powder particles and an insulating resin;
a coil portion disposed in the body and including a lead-out portion having a surface exposed through a first surface of the body; and
an external electrode disposed on the first surface of the body,
wherein the external electrode includes,
an intermetallic compound (IMC) disposed on the lead-out portion exposed to the first surface of the body and having an average thickness of 1 μm or more, and
a first electrode layer including a base resin, and a conductive connection portion disposed in the base resin and in contact with the intermetallic compound.

2. The coil component of claim 1, wherein an average thickness of the intermetallic compound is 10 μm or less.

3. The coil component of claim 2, wherein the average thickness of the intermetallic compound is 3 μm or less.

4. The coil component of claim 1, wherein the intermetallic compound comprises a metal having a melting point lower than a curing temperature of the base resin.

5. The coil component of claim 4, wherein the intermetallic compound comprises copper (Cu) and tin (Sn).

6. The coil component of claim 4, wherein the conductive connection portion comprises a metal having a melting point lower than the curing temperature of the base resin.

7. The coil component of claim 6, wherein the conductive connection portion comprises at least one of copper (Cu) and silver (Ag), and tin (Sn).

8. The coil component of claim 6, wherein the intermetallic compound is provided as a plurality of intermetallic compounds spaced apart from each other on the exposed surface of the lead-out portion.

9. The coil component of claim 6, wherein the external electrode further comprises a second electrode layer disposed on the first electrode layer and in contact with the conductive connection portion.

10. The coil component of claim 6, wherein the first electrode layer further comprises metal powder particles at least partially covered by the conductive connection portion.

11. The coil component of claim 10, wherein a shape of the metal powder particles is one of a spherical shape, a flake type, and a mixed type of a sphere and a flake type.

12. The coil component of claim 6, further comprising a substrate disposed in the body and provided with the coil portion disposed on at least the first surface.

13. The coil component of claim 12, wherein the first electrode layer extends to at least a portion of each of a plurality of surfaces of the body connected to the first surface of the body.

14. The coil component of claim 6, wherein the coil portion is a winding coil.

15. The coil component of claim 14, wherein the first electrode layer extends to at least a portion of each of a plurality of surfaces of the body connected to the first surface of the body.

16. The coil component of claim 14, wherein the first electrode layer extends from the first surface of the body to only one of a plurality of surfaces of the body connected to the first surface of the body.

17. The coil component of claim 14, wherein the lead-out portion of the coil portion comprises first and second lead-out portions exposed to be spaced apart from each other on the first surface of the body, and
the external electrode comprises first and second external electrodes in contact with the first and second lead-out portions, respectively, and spaced apart from each other on the first surface of the body.

18. A coil component comprising:
a body comprising an insulating resin and magnetic powder particles dispersed in the insulating resin;
a coil portion embedded in the body, the coil portion comprising a lead-out portion extending to a first surface of body;
an intermetallic compound disposed on the lead-out portion, the intermetallic compound being at least 1 μm thick;
an external electrode disposed on the first surface, the external electrode comprising a first electrode layer including a base resin and a conductive connection portion disposed therein, the conductive connection portion being in direct contact with the intermetallic compound.

19. The coil component of claim 18, wherein at least one of the intermetallic compound and a metal comprised in the conductive connection portion have a melting point less than a curing temperature of the base resin.

20. The coil component of claim 18, wherein the intermetallic compound comprises a plurality of regions spaced apart from each other, and wherein the conductive connection portion is in direct contact with at least a portion of the plurality of regions.

21. The coil component of claim 18, wherein the intermetallic compound has a thickness in a range from 1 μm to 10 μm.

22. The coil component of claim 18, wherein the external electrode further comprises a second electrode layer disposed on the first electrode layer, and wherein the second electrode layer directly contacts the conductive connection portion.

23. The coil component of claim 18, wherein the first electrode layer further comprises metal powder particles at least partially covered by the conductive connection portion.
